(19) United States
(12) Patent Application Publication
(10) Pub. No.: US 2020/0226527 A1
(43) Pub. Date: Jul. 16, 2020

(54) Time Valuation System

(71) Applicant: Robert Warren, Salt Lake City, UT (US)

(72) Inventors: Robert Lee Warren, Salt Lake City, UT (US); Ryan John Hagge, Lehi, UT (US); Scott Marsden Jones, South Jordan, UT (US)

(73) Assignee: Robert Warren, Salt Lake CIty, UT (US)

(21) Appl. No.: 16/247,517

(22) Filed: Jan. 14, 2019

(51) Int. Cl. G06Q 10/06

(52) U.S. Cl. CPC G06Q 10/06398; G06Q 10/06393

(57) ABSTRACT

A novel system for determining value of time spent on productive and non-productive activities and the impact of distractions during those activities. This invention provides benefits far greater than scheduling, time management, and parental control systems and will bring other benefits and extensions inherent in its design and application.

This application claims the benefit of U.S. Provisional Application No. 62/617,590, entitled “Time Valuation System,” filed Jan. 15, 2018, the contents of which are hereby incorporated by reference.

### BACKGROUND OF THE INVENTION

The phrase “time is money” is used often without consideration to what it really means. In the abstract sense, it is a pithy way to convey the need for some action, but many people have little sense of the connection beyond an hourly wage or time-based payment. For those who may not have regular employment and wage, considering the value of time can be rather difficult. That is the purpose of this invention.

This disconnect between time and its value has become more evident in the instant-access world today. The impact of devices like smartphones, tablets, computers and other Internet-connected devices, including smart devices like televisions, appliances, and others, are contributing to the disconnect between time and value. This is particularly evident with younger people, including many primary and secondary school and college students.

It is the impact of technology and the increasingly evident problems associated with those impacts that serve as the basis for the invention disclosed herein: a novel way to help people value their time, including using electronic devices, and understand the cost impacts of their non-productive activities.

### SUMMARY OF THE INVENTION

This invention is a system for valuing time in a manner that will help users quickly discern and understand the time spent in productive and non-productive ways. Further, a novel feature of this system is the use of one or more factors to determine a value for such productive and non-productive time and to present this information to a user. This is in contrast with time management, scheduling and parental control systems that are used to simply monitor and track time spent on given activities or restrict specific usage.

A core feature of the preferred embodiment of this invention is to attribute a monetary value to a user's time and then allocate this value per unit time to various activities of the user. A particularly novel aspect of this invention is the ability for variables to be set in order to personalize the characterization and valuation of time. These allocations may additionally be considered in context of activity, time of day, or other variables.

These time valuations are presented in a manner that allows a user or other(s) to understand and make use of the information. It may also be used to provide future guidance based on specific targets of time valuation.

### DETAILED DESCRIPTION OF THE INVENTION

In the ever-increasingly fast-paced world, time is of the essence for many people. Managing time, whether personal or professional, has become a fine tuned skill for many who attempt to maximize the effectiveness of their time. For some, this time management effort may be as simple as a schedule, while for others who require finer granularity in time usage, advanced time management systems are employed. Many of these people and others who do not use a schedule or time management system, however, do not really understand the value of their time.

Attorneys, consultants, and tradespeople who charge for their time know specifically what their time is worth to their customers. Similarly, people who work for a wage know what value their employer puts on time. Others do not have an easy way to value their time in an objective manner. What is shared by those who do or do not have an objective measure of the value of their time is the inability to measure the value of time lost to interference, distractions, and other interruptions to their time. That ability to distinguish between productive and non-productive time and to value each is the basis for this invention.

The determination of what may be considered productive or non-productive is valuable because it provides a direct measure of lost time, which is more difficult for some people to understand. As set forth in this invention, the attribution of value for the lost time puts the lost time in measurable and readily understandable terms. This allows action to be taken and to be measured in terms of effectiveness.

Importantly, the constraints on the measure may be configured as necessary to personalize the system. Details, including valuation of time, measure specifics, and context of the time may be settable by the user, including directly on the device, by others, including one or more family members, an employer or employer representative, a sponsor, or by the system of this invention. In this last case, the allocations may be derived from other users or a subset of other users or with the use of profiles for different types of users.

This time valuation invention may take one of several forms, but is most likely to be in the form of a computer or smartphone or other electronic device (hereinafter referred to as a “device”) software application. Alternatively, the invention may take the form of a web site that may be accessed from any Internet-connected device

In the preferred embodiment, the time valuation system will automatically log user activities such as time spent on a device. In an extension, this logging will be integrated with other inputs. These other inputs may come from other devices (e.g., home computer, health monitor) or it may come from manual input. Manual input will cover tasks that are not, and perhaps cannot be, easily monitored by a device. Such inputs may include sleep, study sessions, and other non-electronic device activities.

In the preferred embodiment, there will be allocations that vary with the amount of time spent on a given activity. For example, enjoying entertainment in the form of playing a video game may be a great opportunity to relieve stress if the game is played for a limited time, e.g., thirty minutes, and may be considered a positive time valuation in that context. However, this same entertainment form, if played for hours on end, then be deemed as a negative and have a time valuation reflecting this negative value.

The user interface in a preferred embodiment will provide a summary of the status of valuation over specific periods, including the day, the most recent week, or longer time spans. This embodiment may also include the ability to configure the system to user-specific needs.

In the preferred embodiment, manual input will also be implemented such that the category of activity is selected and a timer is presented. At the start of the activity, the timer is started by the user and allowed to run until stopped by the user. An enhancement to this manual timer feature is to periodically query the user to confirm the activity is still underway. Another enhancement will be to have a limit on the activity, set automatically by the time valuation application, by the user, or by a third-party (e.g., a parent) who has the ability to set such limits. In this case, an alarm or alert will be presented to the user to notify that time has expired.

For example, a game may be considered non-productive but an educational website or news application may be considered productive. The determination of what may be considered productive or non-productive may be settable by the user, including directly on the device, by others, including one or more family members, an employer or employer representative, or others.

Further, in the preferred embodiment, each user will have a specific value per unit of time so that any time—productive or non-productive—may be attributed a value based on the amount of time and the specific value per unit of time. This specific value per unit of time may be provided by the user directly, determined by a series of metrics, or provide based on one or more profiles that have been developed.

In one embodiment, the user value per unit time is directly related to the hourly wage earned while working. Unlike other, more speculative measures, this is an objective value that a third party, typically an employer, has placed on the user. In another embodiment that is particularly useful for students who may not be employed, the user is asked one or more questions to gauge the value per unit time. Questions may range from a simple query as to the user's perceived value or a relative sense of how much value they attribute to tasks over a specific length of time.

In addition to attributing positive or negative value to actions, in the preferred embodiment, the time valuation system invention will consider the long-term value of some activities. Such activities, which may be considered investments of time, may include reading, research, practice, and other activities that may or may not necessarily have a near-term benefit but may be productive in the pursuit of a goal set for some time in the future, e.g., acceptance into a high-level college program. There may be other types of time valuations as well, such as, but not limited to, neutral time valuation, where the users neither gains nor loses value during activities.

The preferred embodiment of the system will allow for additional information to be integrated into a given user's profile. This will be particularly useful for activities that may not be recorded on the device. Such activities may include reading, physical activity, attending meetings and lectures, and myriad others. In the preferred embodiment, these additional activities may be added into the system by the user or some other means.

In a preferred embodiment of the system, information for one or more users will be aggregated to help establish profiles that may be used throughout the system. For example, a plurality of high school student users may serve as the basis for a development of a high school student profile or a series of profiles, including a range from high performing to low performing students.

In one embodiment of this invention, a goal setting system will be established by providing profiles of time usage and the resulting valuation for users to utilize as targets. An enhancement of this feature is to use well-known people as model profiles for people to attempt to emulate. An example is to consider Microsoft founder Bill Gates and how he, through his actions, values his time. A user of this invention may use a profile based on how Bill Gates spends his time as a reasonable goal in order to be successful.

In another embodiment of this time valuation system is the ability to engage family members. This engagement may result from parents working to establish boundaries and expectations of how time is spent. This may take the form as an accumulation of value over a specific period, e.g., a day or week, which, if met, will provide new provide a justification for new activities or other gain, including financial gains. This value may be compared to other family manners to develop a profile of the family as a whole.

Yet another embodiment of this invention includes the ability to build contests and other incentive systems around user performance. For example, a group of users may be pitted against each other in the pursuit of a specific valuation target. Variations on this embodiment are that the groups or contests may be specified by various hosts, including schools, companies, or other entities that are trying to sway activities in a particular manner.

The engagement of various institutions, including schools, companies, organizations, and other entities, in setting limits or target profiles is available in another embodiment of the invention. For schools and companies, for example, the goal may be to minimize distractions and negative time valuations by weighting the negatives far higher than in a standard case. Still others, including organizations, may weight specific activities, e.g., exercise time, higher in order to induce higher levels of participation in those related activities.

An embodiment of the invention includes the ability to aggregate activity and time valuation information across multiple devices. A simple case to consider is the combination of data from both a smartphone and a home computer. This embodiment may also be extended to included unrelated devices like fitness monitors, which are better able to provide physical activity information for the user.

An enhancement is to accept environmental information to assist in determining actions. This may include the use of a location-based system like GPS or iBeacon, but it may also include wireless systems that can be identified to determine a location, e.g., a library wireless system. Additionally, a lack of any wireless or other environmental information may provide useful information, like the user being outdoors or the device being hidden away.

An extension of this embodiment is to aggregate user data into a database that can be used to help set levels and thresholds for other users. This aggregation may be done anonymously in order to respect privacy and to allow for averaging and normalizing data based on one or more categories, e.g., age, grade level, career aspirations.

An alternative embodiment of the time valuation system is to provide contextual settings. That is, some settings or limits may be most suitable for weekdays while working, but others may be best suited for weekends, vacation periods, or other different times. Moreover, this embodiment may be enhanced by integrating these various contexts across a longer time horizon to ensure that specific contexts, like vacation days, are not taken to an extreme and therefore skew overall time valuations.

Another alternative embodiment of this invention is that the application or means of gathering information is not installed or engaged by the user, but by a third-party. This embodiment may be enhanced by ongoing operations being unknown or rendered inaccessible by the user. A further enhancement is that any attempt by the user to access, impair, or attempt to or actually remove the system will trigger an alert notification to the party responsible for installing the system.

Related to this is a feature embodiment that will allow only summary information to be accessed by a user. Further, summary or comprehensive data may be available to a third party. In this embodiment, either configuration data and variables can be set in another form, including a website, or set by others and not the user.

While the per unit time valuation is set by the user or third-party in the preferred embodiment, an alternative embodiment provides the per unit time valuation to be set based on local information or factors. For example, the per unit time variable will likely be different between users in a large city versus a small farming community or in a different country. In this embodiment, this local information can give a more relevant perspective of time usage to the user. This may be configurable such that a user may be able to adopt local information that does not necessarily apply to them by default. For example, a city dweller may want to use the system to determine how they may place in a different location. This feature may be further enhanced with adjustments, actual or projected, variables like inflation, foreign exchange rates and other factors.

Yet another embodiment, based on, but independent of, the previous embodiment, is the ability of the system to convey what lifestyle may be available to the user based on their own time valuation, including investment in the future.

A further enhancement of this system is the ability to project, based on user or other input, the long-term value of time investment. This will allow the user to use a career aspiration, whether real or hypothetical, and the potential per unit time valuation as the basis for a pay-off of the user's time investment.

Another system embodiment is to include various disclaimers about the accuracy of any provided data. For example, data provided to a user may be based on wide range averages and therefore not specifically accurate to a given user. Such disclaimers may be presented to the user periodically, particularly when accessing summary data, specific details of aspirational goals or at other times.

Yet another embodiment of this system is to integrate what-if type or optional scenarios for consideration. For example, the system, based on user input, may be useful to determine specific career paths and the trade-offs of time spent in order to achieve those paths. This may be further extended to considering factors like college loans and other financing efforts.

In one embodiment, calculations of the valuation of time spent on activities is done as the activities occur or are anticipated, perhaps by scheduling, to occur. This will allow users to know their status in real-time or near real-time.

An enhancement to this embodiment is the ability to revise real-time information based on actual events, including interruptions. For example, a planned time for classes will typically be considered as a positive activity. However, receiving text messages during that time disrupts the overall positive rating of the class and may, based on frequency and time spent, drive the overall valuation of the period to negative.

A further enhancement to this embodiment is the ability to link series of events, like text messages, into a composite event that will have a greater impact that when considering individual events alone. This may be best considered in the case of text messages. Individually, text messages may take seconds of time to read and respond. However, a series of text messages and responses can effectively monopolize the focus of the user. In this case, for example, perhaps five text messages and responses, while consuming only one minute each (five minutes total) over a twenty minute period, will effectively consume the attention of the user for the entire twenty minutes and then result in some lingering effect extending the time impact even further.

In yet another embodiment, to differentiate between time spent focusing on a task or time that is interrupted, the system will calculate a metric to attribute the quality of the time and/or attention on a given task. This feature will provide a useful rating on how valuable the time spent really was prior to attributing a monetary value to the time.

Another embodiment of this time valuation invention is the user of machine learning or other deep learning techniques to develop model profiles. With collection of user data, the invention's use of machine learning and statistics will be able to develop profiles that include the characteristics for various types of success. For example, users who aspire to achieve a specific type of college degree or entry-level job salary will be able to benefit from the model profiles as a comparison and the ability to adopt the parameters of the machine learning-generated model profile.

### Example

The invention disclosed herein is novel in several respects. This example to follow provides a preferred embodiment incorporating novel features of the invention.

A user installs onto the user's smartphone, computer, and internet-connected television software containing the invention disclosed herein. Setting user-specific variables, either via direct settings, using system defaults, or using system-provided settings based on various user or demographic information. One of the settings by the user is that the user's time rate is worth $15 per hour. The user bases this on current job compensation or an aspirational job that is within the user's ability. Using the information from the apps, user input, and any other sources, the invention creates a composite of activities and interruptions experienced by the user.

The user goes about normal activities and the system collects information from the various devices without user intervention. The system of this invention uses various techniques to account for interruptions and distractions during normal activities. These techniques result in a metric for a specified period of time. This value is then used in combination with the hourly time rate previous set to provide the user with a specific value of time, including a cost, i.e., negative value, of the interruptions encountered during the time.

What is claimed is:

1. A system to determine a value of time spent on one or more activities and provides information in a usable form.

2. The time value system of claim 1 in which the unit value of time is determined by at least one of the following: the user's selection, the user's employment pay, a third party, a reference value determined by some aggregation of similar demographics, geography, or socio-economic class, a projection of future professional income, or other source.

3. The time valuation system of claim 1 that determines if activities are productive or non-productive

4. The time valuation system of claim 1 in which an activity is a distraction to a planned activity.

5. The planned activities of claim 4 that include at least one of work time, school time, study time, family time, or other scheduled activity.

6. The distractions of claim 4 in which the source of the distractions are externally caused and of at least one of the following types: electronic message, email, phone call, abrupt noise, personal contact, alarm, alert, notification, or other.

7. The distractions of claim 4 in which the distractions are internally caused and of at least one of the following types: web surfing, video game playing, daydreaming, social media, gossiping, watching streaming or broadcast media, messaging, initiating calls, or other.

8. The distractions of claim 4 in which the distractions are a combination of externally and internally caused.

9. The time valuation system of claim 1 in which the information can be augmented with data from other sources or otherwise modified.

10. The time valuation system of claim 1 in which the information is provided in a summary form.

11. The information of claim 1 is provided to at least one of the following: user, designated third party, relevant institution, including school(s), or organization.

12. The information of claim 1 which is aggregated in order to provide one or more comparisons for users.

13. The information of claim 1 is used as part of one or more of: a contest, a competition against other users, or an incentive.

14. A system to determine a value of time spent on one or more activities, interpret the valuations based on various factors, and provides information in a usable form.

15. The time valuation system of claim 14 in which one or more of the factors is based on a user profile.

16. The time valuation system of claim 14 in which one of the factors is one or more goals that are set.

17. The time valuation system of claim 14 which interprets valuation based one or more of the following factors: location, time of day, day or week, holiday status.

18. The time valuation system of claim 14 which uses factors based on thresholds set by one or more of the following: user, designated third party, institution, or organization.

19. The thresholds of claim 18 that include at least one of: time limits, number of distractions, type of distractions, expected activities.

20. The interpretation of claim 14 to consider a sequence of distractions as a single distraction.

21. The interpretation of claim 14 that considers at least one of the following: the quality of a given activity, a projected long-term value of the activity, or as a comparison to a model profile.

22. The time valuation system of claim 14 in which multiple interpretations are made.

23. The multiple interpretations of claim 19 that include at least one of:
interpretation based on projections, what-if, or optional scenarios.

24. A system to determine a value of time spent on one or more activities on one or more electronic devices.

25. The time valuation system of claim 24 in which the devices is at least one of a smartphone, tablet, personal computer, laptop, smart television or appliance, or other communications or media device.

26. The time valuation system of claim 24 in which devices automatically collect information about activities.

27. The time valuation system of claim 24 in which automatically collected information may be augmented or replaced with manually-produced information.

28. The time valuation system of claim 24 in which automatically collected information may be augmented, adjusted or eliminated.
